(19) United States
(12) Patent Application Publication
(10) Pub. No.: US 2025/0337206 A1
(43) Pub. Date: Oct. 30, 2025

(54) POWER CONNECTOR

(71) Applicant: BIZLINK INTERNATIONAL CORP., New Taipei City (TW)

(72) Inventor: Kuang-Shan LI, New Taipei City (TW)

(21) Appl. No.: 18/649,271

(22) Filed: Apr. 29, 2024

(51) Int. Cl. H01R 25/14

(52) U.S. Cl. CPC H01R 25/145

(57) ABSTRACT

A power connector includes at least one terminal assembly, a plurality of fasteners and a pair of locking pieces. The terminal assembly includes a terminal structure. The terminal structure includes a plurality of conductive pieces. Each of the conductive pieces has a plurality of first through holes. Each of the fasteners penetrates through a corresponding one of the first through holes of each of the conductive pieces to secure the conductive pieces in a laminated manner. Each of the locking pieces includes a body. The body is configured to at least partially abut against one of outermost two of the conductive pieces. The body has a plurality of second through holes. Each of the fasteners further penetrates through a corresponding one of the second through holes to secure the body on the conductive pieces.

### BACKGROUND

### Technical Field

The present disclosure relates to power connectors.

### Description of Related Art

In the Chinese patent CN112928512B, an electrical connector 100 is disclosed. The electrical connector 100 includes a plurality of slat-shaped terminals 2 laminated together. Each of the slat-shaped terminals 2 has a pair of cantilevers 22 and a pair of cantilevers 23 located at the same side of a central portion of the said slat-shaped terminal 2. The perpendicular distance between each of the cantilever 22 and the corresponding one of the cantilevers 23 adjacent to the said cantilever 22 increases gradually in a direction away from the central portion of the said slat-shaped terminal 2. In other words, each of the cantilever 22 and the corresponding one of the cantilevers 23 adjacent to the said cantilever 22 are not parallel with each other. Therefore, when a plate-type bus bar 10 is sandwiched between the cantilevers 22 and the cantilevers 23, a distribution of the forces exerting on the cantilevers 22 and the cantilevers 23 by the plate-type bus bar 10 will be uneasy to control, which may cause failure to at least either one of the cantilevers 22 or the cantilevers 23.

### SUMMARY

A technical aspect of the present disclosure is to provide a power connector, which can effectively improve the durability.

According to an embodiment of the present disclosure, a power connector includes at least one terminal assembly, a plurality of fasteners and a pair of locking pieces. The terminal assembly includes a terminal structure. The terminal structure includes a plurality of conductive pieces. Each of the conductive pieces has a plurality of first through holes. Each of the fasteners penetrates through a corresponding one of the first through holes of each of the conductive pieces to secure the conductive pieces in a laminated manner. Each of the locking pieces includes a body. The body is configured to at least partially abut against one of outermost two of the conductive pieces. The body has a plurality of second through holes. Each of the fasteners further penetrates through a corresponding one of the second through holes to secure the body on the conductive pieces.

In one or more embodiments of the present disclosure, each of the first connecting arms includes a central portion, two pair of first connecting arms and two pairs of second connecting arms. The central portion has the first through holes. The two pairs of first connecting arms are respectively disposed on opposite sides of the central portion. Each of the first connecting arms has a first tip away from the central portion. The two pairs of second connecting arms are respectively disposed on opposite sides of the central portion. Each of the second connecting arms has a second tip away from the central portion. Each pair of the first connecting arms is located between a corresponding pair of the second connecting arms. The first tips are located closer to the central portion than the second tips to the central portion. Each of the first connecting arms is at least partially parallel with an adjacent one of the second connecting arms.

In one or more embodiments of the present disclosure, each of the first connecting arms includes a first structural section, a first terminal section and a first bending section. The first structural section is connected with the central portion. The first bending section is connected between the first structural section and the first terminal section. The first bending section is configured to be elastically bent relative to the first structural section. The first terminal section has a corresponding one of the first tips away from the first bending section. Each of the second connecting arms includes a second structural section, a second terminal section and a second bending section. The second structural section is connected with the central portion. The second bending section is connected between the second structural section and the second terminal section. The second bending section is configured to be elastically bent relative to the second structural section. The second terminal section has a corresponding one of the second tips away from the second bending section. Each of the first bending section is parallel with an adjacent one of the second bending sections.

In one or more embodiments of the present disclosure, the conductive pieces are laminated along a direction. The first structural section, the first bending section and the first terminal section of each of the first connecting arms have a constant width on a plane perpendicular to the direction.

In one or more embodiments of the present disclosure, the conductive pieces are laminated along a direction. The second structural section, the second bending section and the second terminal section of each of the second connecting arms have a constant width on a plane perpendicular to the direction.

In one or more embodiments of the present disclosure, the first tips of each pair of the first connecting arms define a first distance therebetween. The second tips of each pair of the second connecting arms define a second distance therebetween. The first distance is equal to the second distance.

In one or more embodiments of the present disclosure, each of the first bending sections is inclined to a corresponding one of the first structural sections.

In one or more embodiments of the present disclosure, each of the second bending sections is inclined to a corresponding one of the second structural sections.

In one or more embodiments of the present disclosure, each of the first bending sections is longer than a corresponding one of the first structural sections.

In one or more embodiments of the present disclosure, each of the second bending sections is longer than a corresponding one of the second structural sections.

In one or more embodiments of the present disclosure, each of the first terminal sections has a convex surface and a concave surface opposite to the convex surface. The convex surfaces of each pair of the first connecting arms face to each other. The concave surfaces of each pair of the first connecting arms face away from each other.

In one or more embodiments of the present disclosure, each of the second terminal sections has a convex surface and a concave surface opposite to the convex surface. The convex surfaces of each pair of the second connecting arms face to each other. The concave surfaces of each pair of the second connecting arms face away from each other.

In one or more embodiments of the present disclosure, the conductive pieces are laminated along a direction. Each of the first connecting arms has a first width on a plane perpendicular to the direction. Each of the second connecting arms has a second width on the plane. The second width is equal to the first width.

In one or more embodiments of the present disclosure, the first connecting arms are structurally symmetrical about the central portion. The second connecting arms are structurally symmetrical about the central portion.

In one or more embodiments of the present disclosure, the conductive pieces are laminated along a direction. Each of the locking pieces further includes a first coupling portion connected with the body. The terminal assembly further includes a conductive plate. The conductive plate is at least partially sandwiched between the first tips and the second tips disposed on one of the two opposite sides of the central portion. The conductive plate has two surfaces and two second coupling portions. The surfaces are perpendicular to the direction. The second coupling portions are respectively located on a corresponding one of the surfaces. Each of the first coupling portions is configured to couple with a corresponding one of the second coupling portions.

In one or more embodiments of the present disclosure, each of the second coupling portions is a groove. Each of the first coupling portions is a hook.

In one or more embodiments of the present disclosure, a quantity of the terminal assembly is two. The power connector further includes a plug and a socket. The socket is configured to couple with the plug. The socket includes a housing and the two terminal assemblies. The two terminal assemblies are at least partially fixed inside the housing for electrical connection with the plug.

In one or more embodiments of the present disclosure, the two terminal assemblies are separated from each other.

In one or more embodiments of the present disclosure, the conductive pieces are sandwiched between the locking pieces.

According to an embodiment of the present disclosure, a power connector includes a conductive slab and a terminal module. The conductive slab has two lateral surfaces opposite to each other. Each of the lateral surfaces has a notch. The terminal module includes a plate stack, two hooking plates and a plurality of fasteners. The plate stack includes a plurality of conductive plates stacked together. Each of the conductive plates has a left clip, a right clip and a central portion connected therebetween. Each of the central portions has a plurality of through holes. A corresponding one of the through holes of each of the conductive plates substantially align to form a tunnel. Each of the left clips clips the conductive slab. The hooking plates are disposed on a top and a bottom of the plate stack and are hooked with a corresponding one of the notches respectively. The fasteners respectively penetrate through a corresponding one of the tunnels to secure the hooking plates with the conductive plates.

The above-mentioned embodiments of the present disclosure have at least the following advantage:
(1) Each of the first connecting arms and each of the second connecting arms have respectively a constant width on a plane perpendicular to the direction along which the conductive pieces are laminated. More specifically, the second width of each of the second connecting arms is equal to the first width of each of the first connecting arms. Therefore, when the conductive plate is at least partially sandwiched between the first tips of the first connecting arms and the second tips of the second connecting arms, the forces exerting on the first connecting arms and the second connecting arms will be more likely to be evenly distributed, which can effectively reduce the risk of damage to either one of the first connecting arms and the second connecting arms. Thus, the durability of the terminal structure and thus the durability of the terminal assembly and the power connector are effectively improved.
(2) Since the first coupling portion of each of the locking pieces is configured to couple with a corresponding one of the second coupling portions of the conductive plate while the fasteners penetrate through the second through holes of the locking pieces and the first through holes of the conductive pieces laminated together, the terminal structure is uneasy to be detached from the conductive plate. Therefore, the structural strength of the terminal assembly and thus the structural strength of the power connector are effectively improved.

### BRIEF DESCRIPTION OF THE DRAWINGS

The disclosure can be more fully understood by reading the following detailed description of the embodiments, with reference made to the accompanying drawings as follows:

FIG. 1 is a schematic view of power connector according to an embodiment of the present disclosure;

FIG. 2 is a schematic view of the socket of FIG. 1;

FIG. 3 is a schematic view of one of the terminal assemblies of FIG. 2;

FIG. 4 is an exploded view of the terminal assembly of FIG. 3; and

FIG. 5 is a top view of a conductive piece of FIGS. 3-4.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

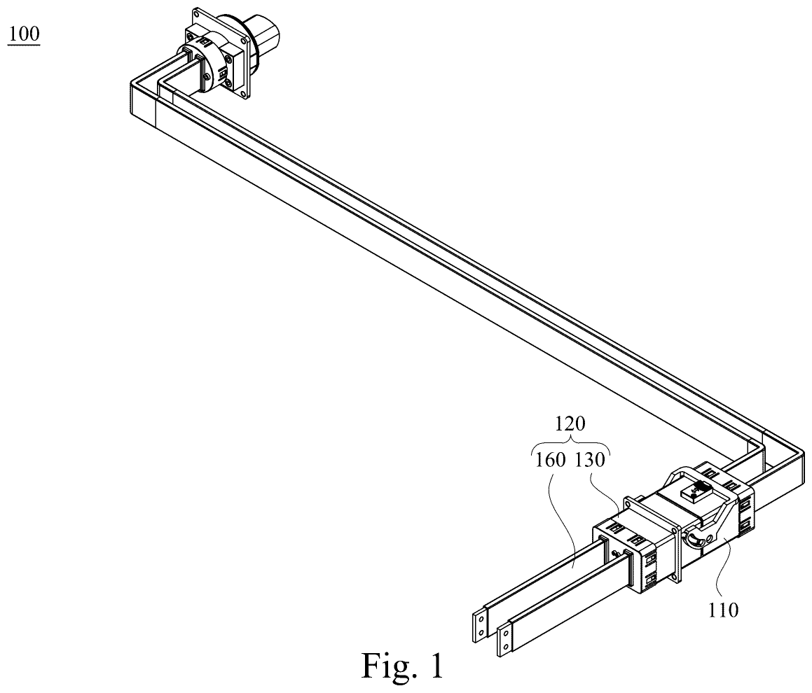

FIGS. 1-5 are drawn according to the actual scale. For the sake of concise description in this specification, the scales of the elements are not listed one by one. However, the scale and position of each element should be regarded as part of the scope of this specification.

Furthermore, if the description in this specification is insufficient to explain the detailed design of the elements and makes it uneasy to implement, please take the electrical connector disclosed in the Chinese patent CN112928512B as a reference.

As shown in FIGS. 1-5, a power connector 100 is provided in the present disclosure. Moreover, for example, the power connector 100 is utilized to connect with an electric vehicle for electrical charging.

FIG. 1 is a schematic view of power connector 100 according to an embodiment of the present disclosure. In this embodiment, as shown in FIG. 1, a power connector 100 includes a plug 110 and a socket 120. The socket 120 is configured to couple with the plug 110 for connection of, for example, a power supply to an electric vehicle.

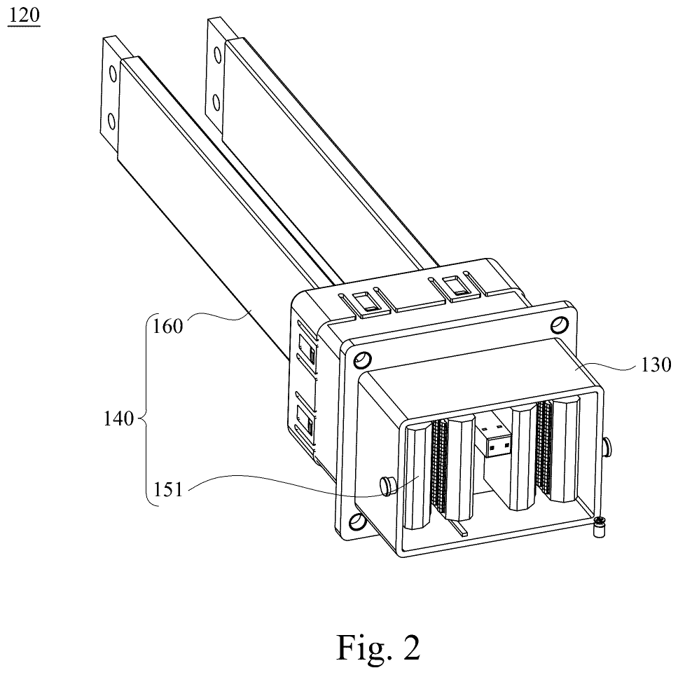

FIG. 2 is a schematic view of the socket 120 of FIG. 1. In this embodiment, as shown in FIG. 2, the socket 120 includes a housing 130 and two terminal assemblies 140. The terminal assemblies 140 are separated from each other and at least partially fixed inside the housing 130 for electrical connection with the plug 110 (please see FIG. 1 for the plug 110).

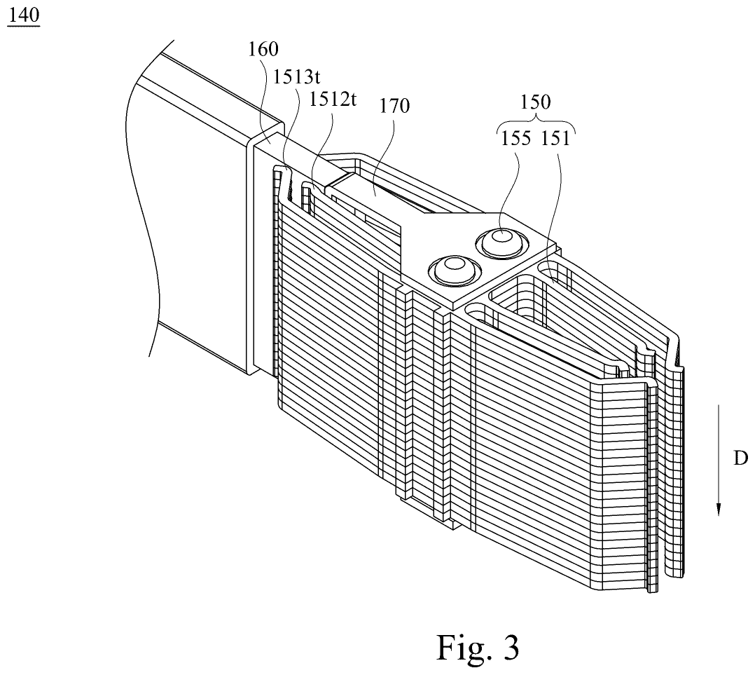

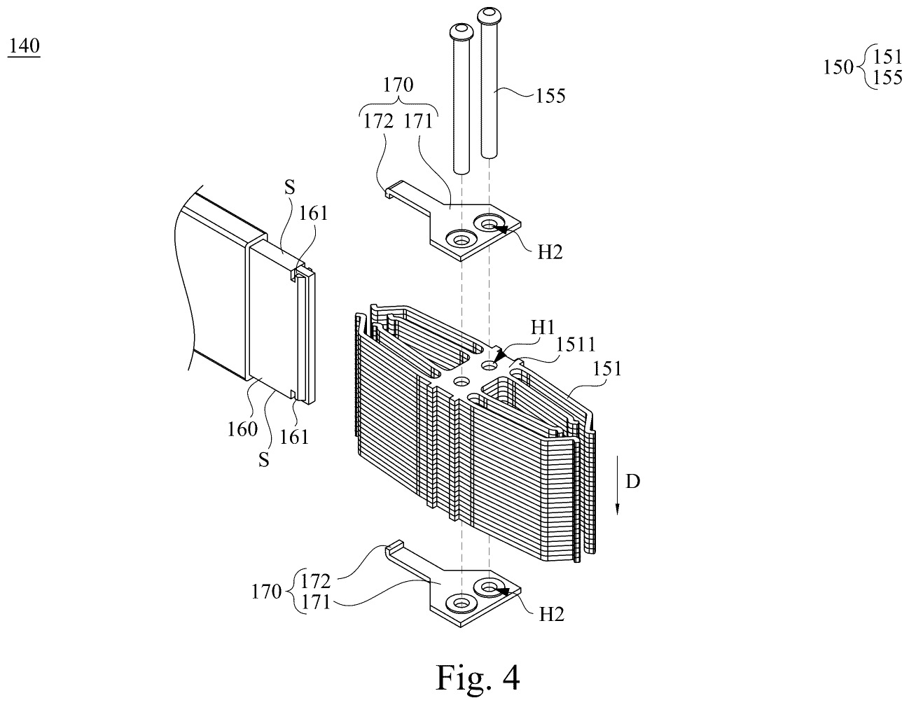

FIG. 3 is a schematic view of one of the terminal assemblies 140 of FIG. 2. FIG. 4 is an exploded view of the terminal assembly 140 of FIG. 3. In this embodiment, as shown in FIGS. 3-4, the terminal assembly 140 includes a terminal structure 150, a conductive plate 160 and a pair of locking pieces 170. The terminal structure 150 includes a plurality of conductive pieces 151 and a plurality of fasteners 155. Each of the conductive pieces 151 is practically shaped as a slat and the conductive pieces 151 are laminated along a direction D.

Furthermore, as shown in FIG. 4, the conductive plate 160 has two surfaces S and two second coupling portions 161. The surfaces S are opposite to each other and perpendicular to the direction D. The second coupling portions 161 are respectively located on a corresponding one of the surfaces S of the conductive plate 160. On the other hand, each of the locking pieces 170 includes a body 171 and a first coupling portion 172. The body 171 of each of the locking pieces 170 has a plurality of second through holes H2. In practical applications, for example, each of the second coupling portions 161 is a groove while each of the first coupling portions 172 is a hook, as shown in FIG. 4.

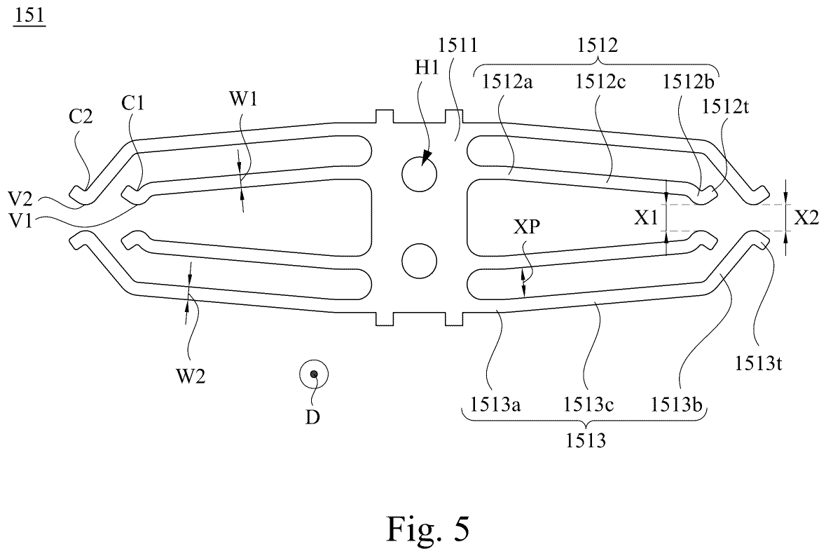

FIG. 5 is a top view of a conductive piece 151 of FIGS. 3-4. In this embodiment, as shown in FIG. 5, each of the conductive pieces 151 includes a central portion 1511, two pairs of first connecting arms 1512 and two pairs of second connecting arms 1513.

Furthermore, as shown in FIG. 5, the central portion 1511 has a plurality of first through holes H1. The two pairs of first connecting arms 1512 are respectively disposed on opposite sides of the central portion 1511 and are structurally symmetrical about the central portion 1511. Each of the first connecting arms 1512 has a first tip 1512t away from the central portion 1511. The two pairs of second connecting arms 1513 are respectively disposed on opposite sides of the central portion 1511 and are structurally symmetrical about the central portion 1511. Each of the second connecting arms 1513 has a second tip 1513t away from the central portion 1511. Each pair of the first connecting arms 1512 is located between a corresponding pair of the second connecting arms 1513. The first tips 1512t are located closer to the central portion 1511 than the second tips 1513t to the central portion 1511. Each of the first connecting arms 1512 is at least partially parallel with an adjacent one of the second connecting arms 1513. In other words, a perpendicular distance XP between each of the first connecting arms 1512 and an adjacent one of the second connecting arms 1513 is a constant.

In addition, as shown in FIG. 5, each of the first connecting arms 1512 includes a first structural section 1512a, a first terminal section 1512b and a first bending section 1512c. The first structural section 1512a is connected with the central portion 1511. The first bending section 1512c is connected between the first structural section 1512a and the first terminal section 1512b. The first bending section 1512c is configured to be elastically bent relative to the first structural section 1512a. The first terminal section 1512b has a corresponding one of the first tips 1512t away from the first bending section 1512c. Similarly, each of the second connecting arms 1513 includes a second structural section 1513a, a second terminal section 1513b and a second bending section 1513c. The second structural section 1513a is connected with the central portion 1511. The second bending section 1513c is connected between the second structural section 1513a and the second terminal section 1513b. The second bending section 1513c is configured to be elastically bent relative to the second structural section 1513a. The second terminal section 1513b has a corresponding one of the second tips 1513t away from the second bending section 1513c. Each of the first bending section 1512c is parallel with an adjacent one of the second bending sections 1513c.

As shown in FIG. 5, the first structural section 1512a, the first bending section 1512c and the first terminal section 1512b of each of the first connecting arms 1512 have a constant width on a plane perpendicular to the direction D (please see FIGS. 3-4 for the direction D). Similarly, as shown in FIG. 5, the second structural section 1513a, the second bending section 1513c and the second terminal section 1513b of each of the second connecting arms 1513 have a constant width on a plane perpendicular to the direction D.

To be specific, as shown in FIG. 5, each of the first connecting arms 1512 has a first width W1 on a plane perpendicular to the direction D. Each of the second connecting arms 1513 has a second width W2 on the plane. The second width W2 of each of the second connecting arms 1513 is equal to the first width W1 of each of the first connecting arms 1512.

In addition, as shown in FIG. 5, each of the first bending sections 1512c is longer than and inclined to a corresponding one of the first structural sections 1512a. Similarly, each of the second bending sections 1513c is longer than and inclined to a corresponding one of the second structural sections 1513a.

Furthermore, as shown in FIG. 5, the first tips 1512t of each pair of the first connecting arms 1512 define a first distance X1 therebetween. The second tips 1513t of each pair of the second connecting arms 1513 define a second distance X2 therebetween. The first distance X1 between each pair of the first tips 1512t is equal to the second distance X2 between each pair of the second tips 1513t.

In addition, as shown in FIG. 5, each of the first terminal sections 1512b has a convex surface V1 and a concave surface C1 opposite to the convex surface V1. The convex surfaces V1 of each pair of the first connecting arms 1512 face to each other and are configured to abut against the conductive plate 160. The concave surfaces C1 of each pair of the first connecting arms 1512 face away from each other. Similarly, each of the second terminal sections 1513b has a convex surface V2 and a concave surface C2 opposite to the convex surface V2. The convex surfaces V2 of each pair of the second connecting arms 1513 face to each other and are configured to abut against the conductive plate 160. The concave surfaces C2 of each pair of the second connecting arms 1513 face away from each other.

As shown in FIGS. 3-4, the conductive plate 160 is at least partially sandwiched between the first tips 1512t and the second tips 1513t disposed on one of the two opposite sides of the central portion 1511. The body 171 of each of the locking pieces 170 is configured to at least partially abut against one of outermost two of the conductive pieces 151, such that the conductive pieces 151 are sandwiched between the locking pieces 170. Each of the fasteners 155 penetrates through a corresponding one of the first through holes H1 to secure the conductive pieces 151 in a laminated manner and a corresponding one of the second through holes H2 to secure the body 171 on the conductive pieces 151, as shown in FIG. 3. Moreover, the first coupling portion 172 of each of the locking pieces 170 is connected with the body 171 and configured to couple with a corresponding one of the second coupling portions 161 of the conductive plate 160, as shown in FIG. 3.

In practical applications, with reference to FIGS. 3-5, when the conductive plate 160 is placed between the first tips 1512t of the first connecting arms 1512 and the second tips 1513t of the second connecting arms 1513, the first bending section 1512c together with the first terminal section 1512b of each of the first connecting arms 1512 are elastically bent relative to the first structural section 1512a while the second bending section 1513c together with the second terminal section 1513b of each of the second connecting arms 1513 are elastically bent relative to the second structural section 1513a. As mentioned above, each of the first connecting arms 1512 and each of the second connecting arms 1513 have respectively a constant width on a plane perpendicular to the direction D along which the conductive pieces 151 are laminated. More specifically, the second width W2 of each of the second connecting arms 1513 is equal to the first width W1 of each of the first connecting arms 1512. Therefore, when the conductive plate 160 is at least partially sandwiched between the first tips 1512t of the first connecting arms 1512 and the second tips 1513t of the second connecting arms 1513, the forces exerting on the first connecting arms 1512 and the second connecting arms 1513 will be more likely to be evenly distributed, which can effectively reduce the risk of damage to either one of the first connecting arms 1512 and the second connecting arms 1513. Thus, the durability of the terminal structure 150 and thus the durability of the terminal assembly 140 and the power connector 100 are effectively improved.

Moreover, since the first coupling portion 172 of each of the locking pieces 170 is configured to couple with a corresponding one of the second coupling portions 161 of the conductive plate 160 while the fasteners 155 penetrate through the second through holes H2 of the locking pieces 170 and the first through holes H1 of the conductive pieces 151 laminated together, the terminal structure 150 is uneasy to be detached from the conductive plate 160. Therefore, the structural strength of the terminal assembly 140 and thus the structural strength of the power connector 100 are effectively improved.

In other words, a power connector 100 includes a conductive slab 160 and a terminal module 140. The conductive slab 160 has two lateral surfaces S opposite to each other. Each of the lateral surfaces S has a notch 161. The terminal module 140 includes a plate stack, two hooking plates 170 and a plurality of fasteners 155. The plate stack includes a plurality of conductive plates 151 stacked together. Each of the conductive plates 151 has a left clip, a right clip and a central portion 1511. The central portion 1511 is connected between the left clip and the right clip. Each of the central portions 1511 has a plurality of through holes H1. A corresponding one of the through holes H1 of each of the conductive plates 151 substantially align to form a tunnel. Each of the left clips clips the conductive slab 160. The hooking plates 170 are disposed on a top and a bottom of the plate stack and are hooked with a corresponding one of the notches 161 respectively. The fasteners 155 respectively penetrate through a corresponding one of the tunnels to secure the hooking plates 170 with the conductive plates 151.

In conclusion, the aforementioned embodiments of the present disclosure have at least the following advantage:
(1) Each of the first connecting arms and each of the second connecting arms have respectively a constant width on a plane perpendicular to the direction along which the conductive pieces are laminated. More specifically, the second width of each of the second connecting arms is equal to the first width of each of the first connecting arms. Therefore, when the conductive plate is at least partially sandwiched between the first tips of the first connecting arms and the second tips of the second connecting arms, the forces exerting on the first connecting arms and the second connecting arms will be more likely to be evenly distributed, which can effectively reduce the risk of damage to either one of the first connecting arms and the second connecting arms. Thus, the durability of the terminal structure and thus the durability of the terminal assembly and the power connector are effectively improved.
(2) Since the first coupling portion of each of the locking pieces is configured to couple with a corresponding one of the second coupling portions of the conductive plate while the fasteners penetrate through the second through holes of the locking pieces and the first through holes of the conductive pieces laminated together, the terminal structure is uneasy to be detached from the conductive plate. Therefore, the structural strength of the terminal assembly and thus the structural strength of the power connector are effectively improved.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A power connector, comprising:
at least one terminal assembly, comprising:
a terminal structure, comprising:
a plurality of conductive pieces, each of the conductive pieces having a plurality of first through holes; and
a plurality of fasteners, each of the fasteners penetrating through a corresponding one of the first through holes of each of the conductive pieces to secure the conductive pieces in a laminated manner; and
a pair of locking pieces, each of the locking pieces comprising:
a body configured to at least partially abut against one of outermost two of the conductive pieces, the body having a plurality of second through holes, each of the fasteners further penetrating through a corresponding one of the second through holes to secure the body on the conductive pieces.

2. The power connector of claim 1, wherein each of the first connecting arms comprises:
a central portion having the first through holes;
two pairs of first connecting arms respectively disposed on opposite sides of the central portion, each of the first connecting arms having a first tip away from the central portion; and
two pairs of second connecting arms respectively disposed on opposite sides of the central portion, each of the second connecting arms having a second tip away from the central portion, each pair of the first connecting arms being located between a corresponding pair of the second connecting arms, the first tips being located closer to the central portion than the second tips to the central portion, each of the first connecting arms being at least partially parallel with an adjacent one of the second connecting arms.

3. The power connector of claim 2, wherein each of the first connecting arms comprises:
a first structural section connected with the central portion;
a first terminal section; and
a first bending section connected between the first structural section and the first terminal section, the first bending section is configured to be elastically bent relative to the first structural section, the first terminal section has a corresponding one of the first tips away from the first bending section,
each of the second connecting arms comprises:
a second structural section connected with the central portion;
a second terminal section; and
a second bending section connected between the second structural section and the second terminal section, the second bending section is configured to be elastically bent relative to the second structural section, the second terminal section has a corresponding one of the second tips away from the second bending section,
wherein each of the first bending section is parallel with an adjacent one of the second bending sections.

4. The power connector of claim 3, wherein the conductive pieces are laminated along a direction, the first structural section, the first bending section and the first terminal section of each of the first connecting arms have a constant width on a plane perpendicular to the direction.

5. The power connector of claim 3, wherein the conductive pieces are laminated along a direction, the second structural section, the second bending section and the second terminal section of each of the second connecting arms have a constant width on a plane perpendicular to the direction.

6. The power connector of claim 3, wherein the first tips of each pair of the first connecting arms define a first distance therebetween, the second tips of each pair of the second connecting arms define a second distance therebetween, the first distance is equal to the second distance.

7. The power connector of claim 3, wherein each of the first bending sections is inclined to a corresponding one of the first structural sections.

8. The power connector of claim 3, wherein each of the second bending sections is inclined to a corresponding one of the second structural sections.

9. The power connector of claim 3, wherein each of the first bending sections is longer than a corresponding one of the first structural sections.

10. The power connector of claim 3, wherein each of the second bending sections is longer than a corresponding one of the second structural sections.

11. The power connector of claim 3, wherein each of the first terminal sections has a convex surface and a concave surface opposite to the convex surface, the convex surfaces of each pair of the first connecting arms face to each other, the concave surfaces of each pair of the first connecting arms face away from each other.

12. The power connector of claim 3, wherein each of the second terminal sections has a convex surface and a concave surface opposite to the convex surface, the convex surfaces of each pair of the second connecting arms face to each other, the concave surfaces of each pair of the second connecting arms face away from each other.

13. The power connector of claim 2, wherein the conductive pieces are laminated along a direction, each of the first connecting arms has a first width on a plane perpendicular to the direction, each of the second connecting arms has a second width on the plane, the second width is equal to the first width.

14. The power connector of claim 2, wherein the first connecting arms are structurally symmetrical about the central portion, the second connecting arms are structurally symmetrical about the central portion.

15. The power connector of claim 2, wherein the conductive pieces are laminated along a direction, each of the locking pieces further comprises a first coupling portion connected with the body, the terminal assembly further comprises:
a conductive plate at least partially sandwiched between the first tips and the second tips disposed on one of the two opposite sides of the central portion, the conductive plate has two surfaces and two second coupling portions, the surfaces are perpendicular to the direction, the second coupling portions are respectively located on a corresponding one of the surfaces, each of the first coupling portions is configured to couple with a corresponding one of the second coupling portions.

16. The power connector of claim 15, wherein each of the second coupling portions is a groove, each of the first coupling portions is a hook.

17. The power connector of claim 15, wherein a quantity of the terminal assembly is two, the power connector further comprising:
a plug; and
a socket configured to couple with the plug, the socket comprising:
a housing; and
the two terminal assemblies at least partially fixed inside the housing for electrical connection with the plug.

18. The power connector of claim 17, wherein the two terminal assemblies are separated from each other.

19. The power connector of claim 1, wherein the conductive pieces are sandwiched between the locking pieces.

20. A power connector, comprising:
a conductive slab having two lateral surfaces opposite to each other, each of the lateral surfaces having a notch; and
a terminal module, comprising:
a plate stack comprising a plurality of conductive plates stacked together, each of the conductive plates having a left clip, a right clip and a central portion connected therebetween, each of the central portions having a plurality of through holes, a corresponding one of the through holes of each of the conductive plates substantially aligning to form a tunnel, each of the left clips clipping the conductive slab;
two hooking plates disposed on a top and a bottom of the plate stack and being hooked with a corresponding one of the notches respectively; and
a plurality of fasteners respectively penetrating through a corresponding one of the tunnels to secure the hooking plates with the conductive plates.
